(19) United States
(12) Patent Application Publication
(10) Pub. No.: US 2026/0149010 A1
(43) Pub. Date: May 28, 2026

(54) FUEL CELL MODULE AND MANUFACTURING METHOD FOR SAME

(71) Applicant: Hitachi High-Tech Corporation, Minato-ku, Tokyo (JP)

(72) Inventors: Noriyuki SAKUMA, Tokyo (JP); Yoshitaka SASAGO, Tokyo (JP); Ryuusei FUJITA, Tokyo (JP); Nobuyuki MISE, Tokyo (JP); Aritoshi SUGIMOTO, Tokyo (JP)

(21) Appl. No.: 19/122,841

(22) PCT Filed: Dec. 9, 2022
(86) PCT No.: PCT/JP2022/045401

§ 371 Date: Apr. 21, 2025

(51) Int. Cl. H01M 8/0276; H01M 8/0282; H01M 8/0286; H01M 8/2483

(52) U.S. Cl. CPC H01M 8/0276; H01M 8/0282; H01M 8/0286; H01M 8/2483

(57) ABSTRACT

An object is to provide a fuel cell system in which, in a fuel cell stack structure in which fuel cells are stacked, mixing of a fuel gas and air in a fuel cell stack is prevented, power generation efficiency is improved, reliability is improved by stable power generation, and cost is reduced.

An aspect of the invention is a fuel cell module including: a structure body in which a first member, a fuel cell, a support substrate that supports the fuel cell, and a second member are stacked; a first supply path provided in the structure body and configured to allow a first gas to be supplied to the fuel cell; a second supply path provided in the structure body and configured to allow a second gas to be supplied to the fuel cell; and a seal member provided between the first supply path and the second supply path, in which the seal member is made of one material and is provided with a step in one surface, and the seal member on an outer peripheral portion of the second supply path has the same thickness.

In a further preferred aspect of the invention, the seal member has a non-uniform density in a region between the first supply path and the second supply path.

### TECHNICAL FIELD

The present invention relates to a fuel cell module.

### BACKGROUND ART

In recent years, a fuel cell has attracted attention as a clean energy source that is capable of high energy conversion and does not emit pollutants such as a carbon dioxide gas and nitrogen oxides. Among fuel cells, a solid oxide fuel cell (hereinafter abbreviated as SOFC) has high power generation efficiency and can use easy-to-handle gases such as hydrogen, methane, or carbon monoxide as a fuel, and thus has many advantages as compared with other systems, and is expected to be a cogeneration system excellent in energy saving and environmental properties. The SOFC has a structure in which a solid electrolyte is sandwiched between a fuel electrode and an air electrode, and a fuel gas such as hydrogen is supplied and air or an oxygen gas is supplied to a fuel electrode side with the electrolyte as a partition wall. In particular, a flat-plate-type SOFC is promising because a high output can be obtained by stacking.

In a flat-plate-type SOFC single cell disclosed in PTL 1, between upper and lower interconnector plates, a substrate having a cell body mounted on a fuel electrode frame, a separator for separating an electrode, a fuel gas, and air, and a gas seal layer for preventing gas leakage between the substrate having a fuel cell mounted thereon and the separator are provided, and the gas seal layer has a three-layer structure of materials having different hardness to achieve both sealing properties and elasticity.

### CITATION LIST

### Patent Literature

PTL 1: JP2011-210423A

### SUMMARY OF INVENTION

### Technical Problem

PTL 1 discloses a structure in which the fuel electrode frame on which the cell body provided with through holes for supplying and discharging the fuel gas and air from and to an outside is mounted and the separator provided with through holes disposed to overlap the fuel gas and air are stacked, a gap between the separator and the substrate on which the fuel cell is mounted is closed by compression, and the fuel gas and an oxidant gas are absorbed by the elastic gas seal layer to prevent gas leakage.

However, since an interface with the fuel electrode frame in contact with the gas seal layer and an interface with the separator are plane surfaces and have constant pressure, it is difficult to prevent gas leakage at the interface with a normal compressive force when a contact area with a seal member increases with an increase in area of the fuel cell caused by an increase in output. In particular, the flow rate of the air needs to be about three to five times larger than that of the fuel gas, a pressure difference occurs due to a difference in flow rate, and the air at a high pressure outside a fuel gas region in the fuel cell disposed at the center passes through the interface of the seal member and is mixed, which causes a decrease in output. In addition, although an air region is on an opposite side of the fuel gas region in the fuel cell, the pressure of the internal air region is high contrary to the above, the gas leakage occurs in the through hole of the fuel gas in an outer peripheral portion, which causes a decrease in power generation output due to a reaction with the fuel gas and a decrease in fuel use efficiency.

The invention is made in view of such problems, and an object thereof is to provide a fuel cell system in which, in a fuel cell stack structure in which fuel cells are stacked, mixing of a fuel gas and air in a fuel cell stack is prevented, power generation efficiency is improved, reliability is improved by stable power generation, and cost is reduced.

### Solution to Problem

An aspect of the invention is a fuel cell module including: a structure body in which a first member, a fuel cell, a support substrate that supports the fuel cell, and a second member are stacked; a first supply path provided in the structure body and configured to allow a first gas to be supplied to the fuel cell; a second supply path provided in the structure body and configured to allow a second gas to be supplied to the fuel cell; and a seal member provided between the first supply path and the second supply path, in which the seal member is made of one material and is provided with a step in one surface, and the seal member on an outer peripheral portion of the second supply path has the same thickness.

In a further preferred aspect of the invention, the seal member has a non-uniform density in a region between the first supply path and the second supply path.

In a further preferred aspect of the invention, the seal member is sandwiched between at least one of the first member and the support substrate and the second member and the support substrate, an elastic modulus of the seal member is less than elastic moduli of the first member, the second member, and the support substrate, and the fuel cell module further includes a fixing member coupled to the structure body by applying a pressure in a stacking direction.

Another aspect of the invention is a manufacturing method for a fuel cell module, and the fuel cell module includes a structure body in which a first plate-shaped member, a fuel cell, a support substrate that supports the fuel cell, and a second plate-shaped member are stacked, a first supply path configured to allow a first gas to be supplied to the fuel cell, a second supply path configured to allow a second gas to be supplied to the fuel cell, and a seal member provided between the first supply path and the second supply path. In the manufacturing method, the seal member is more easily deformed than the first plate-shaped member, the support substrate, and the second plate-shaped member, at least one of the first plate-shaped member, the support substrate, and the second plate-shaped member has a step in a portion in contact with the seal member, a pressure is applied in a stacking direction of the structure body to sandwich the seal member between at least two of the first plate-shaped member, the support substrate, and the second plate-shaped member, thereby forming the step in the seal member between the first supply path and the second supply path, and at least one of the first gas and the second gas is prevented from moving in an in-plane direction of the first plate-shaped member, the support substrate, and the second plate-shaped member by the seal member.

### Advantageous Effects of Invention

A fuel cell system in which, in a fuel cell stack structure in which fuel cells are stacked, mixing of a fuel gas and air in a fuel cell stack is prevented, power generation efficiency is improved, reliability is improved by stable power generation, and cost is reduced can be provided.

### BRIEF DESCRIPTION OF DRAWINGS

FIG. 1 is a schematic perspective view of a fuel cell module.

FIG. 2 is a top plan view of the fuel cell module.

FIG. 3 is a cross-sectional view of a fuel cell module 10 according to Embodiment 1 taken along line A-A.

FIG. 4 is a cross-sectional view of the fuel cell module 10 according to Embodiment 1 taken along line B-B.

FIG. 5 is a top plan view of a power generation cell support substrate 30 according to Embodiment 1.

FIG. 6 is a cross-sectional view of the power generation cell support substrate 30 according to Embodiment 1 taken along line A-A.

FIG. 7 is a plan view of a seal member 31A according to Embodiment 1.

FIG. 8 is a cross-sectional view of the seal member 31A according to Embodiment 1 taken along line A-A.

FIG. 9 is a plan view of a seal member 31B according to Embodiment 1.

FIG. 10 is a top plan view of an electrode substrate 29A according to Embodiment 1.

FIG. 11 is a cross-sectional view of the electrode substrate 29A according to Embodiment 1 taken along line A-A.

FIG. 12 is a cross-sectional view of the electrode substrate 29A according to Embodiment 1 taken along line B-B.

FIG. 13 is a plan view of an electrode substrate 29B according to Embodiment 1 as viewed from a lower side.

FIG. 14 is a cross-sectional view of the electrode substrate 29B according to Embodiment 1 taken along line A-A.

FIG. 15 is a cross-sectional view of the electrode substrate 29B according to Embodiment 1 taken along line B-B.

FIG. 16 is a top plan view of a separator 32 according to Embodiment 1.

FIG. 17 is a cross-sectional view of the separator 32 according to Embodiment 1 taken along line A-A.

FIG. 18 is a cross-sectional view of the separator 32 according to Embodiment 1 taken along line B-B.

FIG. 19 is a cross-sectional view of a fuel cell module of a comparative example.

FIG. 20 is a graph illustrating a leakage rate of the fuel cell module according to Embodiment 1.

FIG. 21A is a cross-sectional view of a shape between an oxidant gas seal portion and a fuel gas seal portion according to Embodiment 1.

FIG. 21B is a cross-sectional view of another shape between the oxidant gas seal portion and the fuel gas seal portion according to Embodiment 1.

FIG. 21C is a cross-sectional view of another shape between the oxidant gas seal portion and the fuel gas seal portion according to Embodiment 1.

FIG. 22 is a cross-sectional view of a power generation cell support substrate according to Embodiment 2.

FIG. 23 is a cross-sectional view in which the power generation cell support substrate and a seal member are stacked according to Embodiment 2.

FIG. 24 is a plan view of an electrode substrate according to Embodiment 3.

FIG. 25 is a cross-sectional view of a power generation cell support substrate according to Embodiment 3 taken along line C-C.

### DESCRIPTION OF EMBODIMENTS

Embodiments (examples) will be described in detail with reference to the drawings. The invention is not to be construed as being limited to the description of the embodiments to be described below. It will be easily understood by those skilled in the art that the specific configuration can be changed within a range not departing from the idea or spirit of the invention.

In configurations of examples to be described below, the same parts or parts having the same function may be denoted by the same reference numerals in different drawings, and redundant descriptions thereof may be omitted.

When there are a plurality of components having the same or similar functions, the description may be made by assigning the same reference signs thereof with different subscripts. However, when there is no need to distinguish the plurality of components, the subscripts may be omitted to make the description.

The notations “first”, “second”, “third”, or the like in the present description are assigned to identify the components and do not necessarily limit the number, the order, or the content thereof. In addition, a number for identifying a component is used for each context, and the number used in one context does not necessarily indicate the same configuration in another context. In addition, this does not prevent a component identified by a certain number from also having a function of a component identified by another number.

To facilitate understanding of the invention, the position, size, shape, range, or the like of each configuration shown in the drawings or the like may not represent the actual position, size, shape, range, or the like. Therefore, the invention is not necessarily limited to the position, size, shape, range, or the like disclosed in the drawings.

Publications, patents, and patent applications cited in the present specification constitute a part of the description of the present specification.

In the present specification, a component represented in a single form includes a plurality of forms unless otherwise clearly described in the context.

The fuel cell according to the present example has a step by changing a height of a portion covering a fuel gas region and a height of a portion covering an air region of a separator or a substrate on which the fuel cell is mounted, which is in contact with a seal member on the same surface.

According to the fuel cell of the present example, when the electrode substrate, the separator, or the substrate on which the fuel cell is mounted, in contact with the seal member, in which the portion covering the fuel gas region is increased in height relative to the portion covering the air region, is stacked and compressed, the thickness of the seal member in contact with the portion covering the fuel gas region is smaller than the thickness of the seal member in contact with the portion covering the air region, the density of the seal member increases, and therefore the fuel gas is prevented from flowing to the outside and air is prevented from flowing to an inside. Other technical problems and novel features will become apparent from the description of the present description and the accompanying drawings. The “same thickness” described in the present description refers to a thickness that is substantially the same in terms of manufacturing or structure, and an error of about 20 μm is considered to be the same thickness.

### EXAMPLE 1

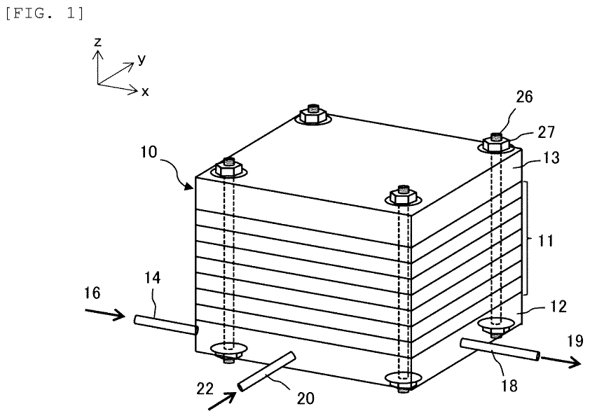

FIG. 1 is a schematic view illustrating a configuration of a fuel cell module 10 according to Embodiment 1.

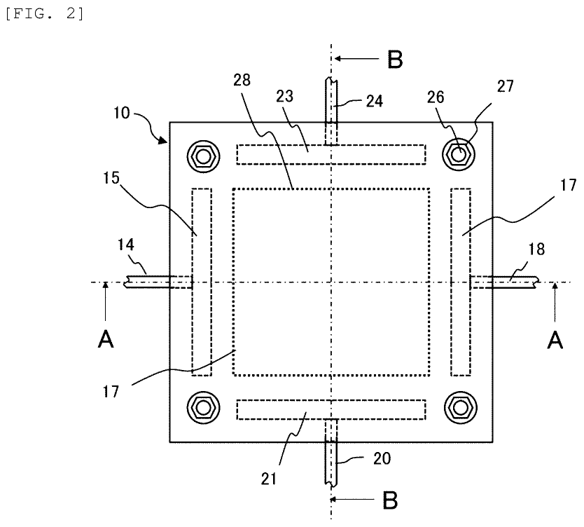

FIG. 2 is a plan view of the fuel cell module 10 as viewed from an upper side. In FIG. 1 and FIG. 2, to facilitate understanding of the configuration of the fuel cell module 10, some configurations are illustrated transparently with dashed lines and illustration of some components are omitted.

In the present description, for convenience, a Z-axis positive direction is referred to as an upward direction, a Z-axis negative direction is referred to as a downward direction, and the fuel cell module 10 may be provided in a direction different from such a direction. The same applies to FIG. 2 and subsequent drawings.

The fuel cell module 10 includes a fuel cell stack 11 (a stack of power generation units) between a base plate 12 and a top plate 13. As will be described later, between the base plate 12 and the top plate 13, a seal member 31 that serves to prevent gas leakage and serves as a gas flow path is provided in the fuel cell stack 11, each member is processed with through holes through which bolts 26 pass, and upper and lower sides are fastened with nuts 27 at a constant pressure. In Embodiment 1, the bolts 26 are provided outside a power generation cell (also referred to as a fuel cell) 28 that serves as a power generation region, at four locations in the fuel cell module 10, but the disposition locations and the number of disposition locations may be changed by setting the fastening pressure.

For example, in the base plate 12, an oxidant gas supply pipe 14 is connected, an oxidant supply gas 16 is supplied into the fuel cell stack 11 through an oxidant gas supply flow path 15 provided inside the base plate 12, and an oxidant discharge gas 19 is discharged from an oxidant gas discharge pipe 18 through an oxidant gas discharge flow path 17 after power generation in the power generation cell 28.

For example, a fuel gas supply pipe 20 is connected to the base plate 12 rotated by 90° in a Y-X plane from the oxidant gas supply pipe 14. A fuel supply gas 22 supplied from the fuel gas supply pipe 20 passes through a fuel gas supply flow path 21 provided inside the base plate 12, is supplied to the power generation cell 28 in the fuel cell stack 11, and then is discharged to an outside as a fuel discharge gas 25 through a fuel gas discharge flow path 23 and a fuel gas discharge pipe 24 after the power generation.

In Embodiment 1, a direction of the gas pipe and a shape of a pipe connection portion are merely examples, and it is sufficient that the function is the same even when the size or the shape is changed. The oxidant supply gas 16 may be air, and the fuel supply gas 22 may be hydrogen, methane, carbon monoxide, or a reformed gas containing a mixture of these gases or water vapor. Materials of base plate 12, the top plate 13, the bolts 26, and the nuts 27 use stainless steel metal.

FIG. 3 is a cross-sectional view taken along line A-A in FIG. 2. As illustrated in FIG. 3, in the fuel cell module 10, an electrode substrate 29A made of metal is stacked via a seal member 31B on the base plate 12 including the oxidant gas supply pipe 14, the oxidant gas supply flow path 15, the oxidant gas discharge flow path 17, and the oxidant gas discharge pipe 18 on a lower side. Next, a power generation cell support substrate 30 on which the power generation cell 28 is mounted is stacked via a seal member 31A, and a separator 32 made of metal is further stacked via the seal member 31A.

A current collector 33 made of porous metal is inserted above and below the power generation cell 28 to electrically connect an anode electrode 41 of the power generation cell 28 and the electrode substrate 29A and a cathode electrode 43 and the separator 32. Details of the power generation cell 28 will be described later with reference to FIG. 6 and the like.

Next, after the current collector 33 is inserted via the seal member 31A, the power generation cell support substrate 30 is stacked again, the seal member 31A and the current collector 33 are inserted, and the separator 32 is stacked. A configuration in which the power generation cell support substrate 30 is sandwiched between an electrode substrate 29B and the separator 32 or a configuration in which the power generation cell support substrate 30 is sandwiched between the separators 32 on the upper and lower sides constitutes one power generation unit 34. In Embodiment 1, a case is described in which three power generation units 34 are stacked. The power generation units are further stacked to form a fuel cell stack capable of obtaining high output. Although not illustrated, the electrode substrate 29A and the electrode substrate 29B are connected to the outside by wirings such that an output to the outside can be performed.

As will be described in detail later, the electrode substrate 29A, the seal members 31A and 31B, and the power generation cell support substrate 30 are commonly provided with, at outer peripheral portions, an oxidant supply gas through hole 36 for supplying the oxidant supply gas 16, an oxidant discharge gas through hole 37 for discharging the oxidant supply gas 16, and through holes 35 (not illustrated) serving as screw holes for the bolts 26. An oxidant gas flow path 49 for discharging the oxidant supply gas 16 through the cathode electrode 43 of the power generation cell 28 is formed below the separator 32 and on the electrode substrate 29B. A fuel gas flow path 46 for supplying and discharging the fuel gas is formed on an anode electrode 41 side of the power generation cell 28.

At this time, in the electrode substrate 29A and an upper portion of the separator 32, there is a step having a changed thickness in a fuel gas seal portion 47 and an oxidant gas seal portion 48 between the fuel gas flow path 46 and the oxidant supply gas through hole 36. When the top plate 13 and the base plate 12 are compressed by the nuts 27 in a final step of manufacturing the fuel cell module, since the seal member 31A has a small elastic modulus, a thickness of the seal member 31A changes following the step. Therefore, the seal member 31A in contact with the fuel gas seal portion 47 becomes thin and has a higher density.

Next, a flow of an oxidant gas in the fuel cell module of Embodiment 1 will be described. The flow of the oxidant gas is indicated by arrows in FIG. 3. For example, the oxidant supply gas 16 at room temperature passes through the oxidant gas supply flow path 15 of the base plate 12 from the oxidant gas supply pipe 14 in the lower portion of the fuel cell module 10 maintained at a constant temperature (for example, 500° C. or higher), passes through the seal member 31B, the electrode substrate 29A, the seal member 31A, and the oxidant supply gas through hole 36 of the power generation cell support substrate 30, is supplied to the power generation cells 28 of each layer, and is discharged to the outside through the oxidant gas discharge pipe 18 from the oxidant discharge gas through hole 37 forming a flow path for discharging the oxidant gas.

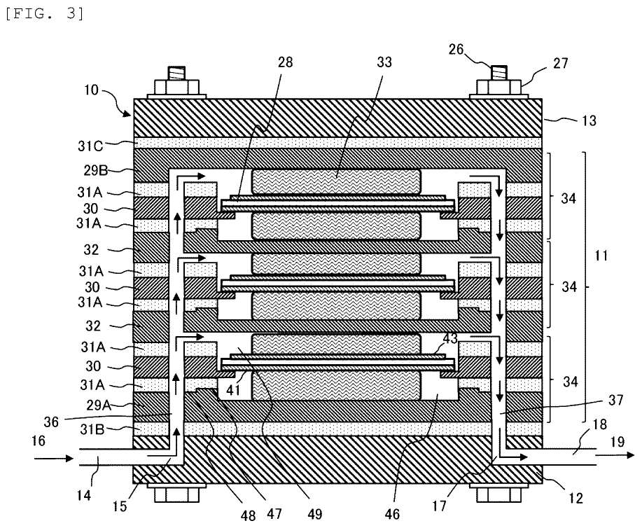

FIG. 4 is a cross-sectional view taken along line B-B in FIG. 2. As illustrated in FIG. 4, in the fuel cell module 10, the electrode substrate 29A made of metal is stacked via the seal member 31B as in the configuration of FIG. 3 on the base plate 12 including the fuel gas supply pipe 20, the fuel gas supply flow path 21, the fuel gas discharge flow path 23, and the fuel gas discharge pipe 24 on the lower side. Next, the power generation cell support substrate 30 on which the power generation cell 28 is mounted is stacked via the seal member 31A, and the separator 32 made of metal is further stacked via the seal member 31A. The current collector 33 made of porous metal is inserted above and below the power generation cell 28 to electrically connect the anode electrode 41 of the power generation cell 28 and the electrode substrate 29A and the cathode electrode 43 and the separator 32. Next, after the current collector 33 is inserted via the seal member 31A, the power generation cell support substrate 30 is stacked again, the seal member 31A and the current collector 33 are inserted, and the separator 32 is stacked. The power generation unit 34 has the same configuration as described above.

A difference from FIG. 3 is that the fuel gas flow path 46 for discharging the fuel supply gas 22 via the anode electrode 41 of the power generation cell 28 is formed on the electrode substrate 29A and on the upper side of the separator 32. The oxidant gas flow path 49 for supplying and discharging the oxidant gas as described above is formed on a cathode electrode 43 side of the power generation cell 28.

At this time, in the electrode substrate 29B and the lower portion of the separator 32, there is a step having a changed thickness in the fuel gas seal portion 47 and the oxidant gas seal portion 48 between the oxidant gas flow path 49 and the fuel supply gas through hole 38. When the top plate 13 and the base plate 12 are compressed by the nuts 27 in the final step, since the seal member 31A has a small elastic modulus, the thickness of the seal member 31A changes following the step. Therefore, the seal member 31A in contact with the fuel gas seal portion 47 becomes thin and has a higher density.

Next, a flow of the fuel gas indicated by arrows in FIG. 4 will be described. Similarly to the oxidant supply gas 16, the fuel supply gas 22 passes through the fuel gas supply flow path 21 of the base plate 12 from the fuel gas supply pipe 20 in the lower portion of the fuel cell module 10 maintained at a constant temperature (for example, 500° C. or higher), passes through the seal member 31B, the electrode substrate 29A, the seal member 31A, and the fuel supply gas through hole 38 of the power generation cell support substrate 30, is supplied to the power generation cells 28 of each layer, and is discharged to the outside through the fuel gas discharge pipe 24 from the fuel discharge gas through hole 39 forming a fuel discharge gas flow path.

In general, a flow rate of the oxidant supply gas 16 needs to be about three to five times that of the fuel supply gas 22, so the pressure of the oxidant supply gas 16 inside the fuel cell module is higher than the pressure of the fuel supply gas 22. Because the temperature inside the fuel cell module is high, a pressure difference caused by gas thermal expansion is said to be several tens of kPa. Therefore, for example, the oxidant supply gas 16 is likely to leak from the oxidant gas flow path 49 to the fuel supply gas through hole 38 through an interface between the seal member 31 and the electrode substrate 29 or an interface between the seal member 31 and the separator 32. However, in Example 1, by providing a step like the oxidant gas seal portion 48 and the fuel gas seal portion 47 on one surface of the electrode substrate 29 or the separator, an effect of preventing the oxidant supply gas 16 from leaking to the fuel gas supply flow path is obtained. Hereinafter, each component will be described.

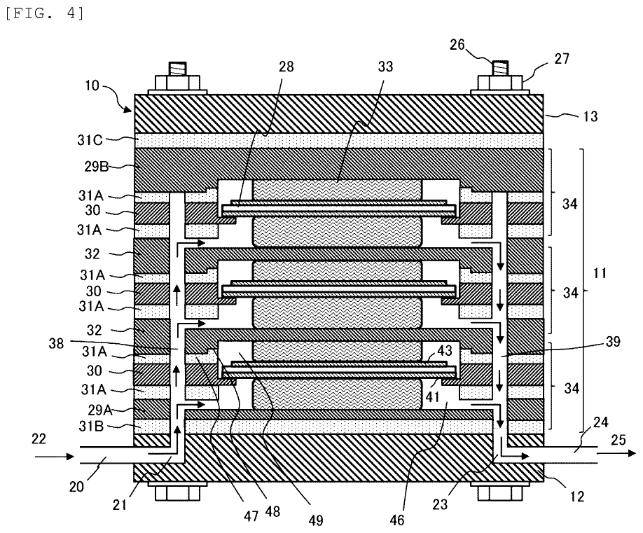

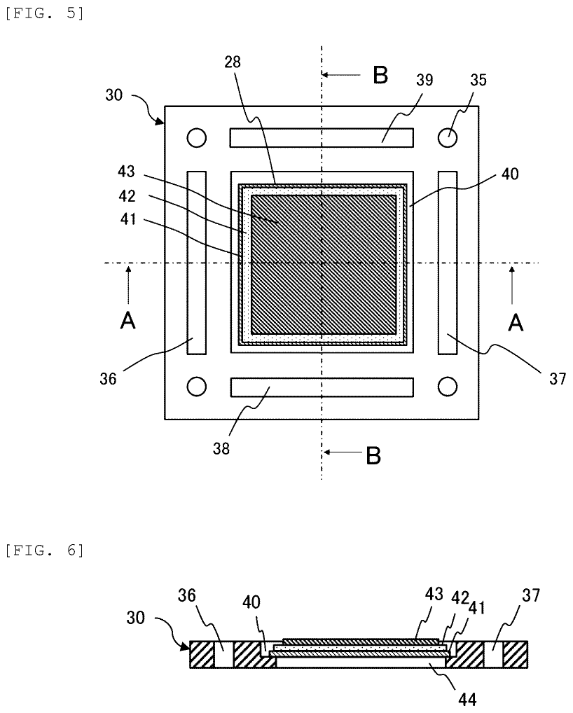

FIG. 5 is a top plan view of the power generation cell support substrate 30 according to Embodiment 1.

FIG. 6 is a cross-sectional view taken along line A-A in FIG. 5. The power generation cell support substrate 30 has an outer shape the same as that of the base plate 12 and that of the top plate 13, and a material thereof uses a ceramic substrate. The through holes 35 for passing the bolts 26 are disposed on the outer peripheral portion at four locations, a power generation cell counterbore 40 for disposing the power generation cell 28 is provided in a central portion, and a depth is such that, for example, when the power generation cell 28 is placed on the power generation cell counterbore 40 and is sealed by adhesive, the power generation cell 28 is slightly higher.

In the power generation cell 28, an electrolyte membrane 42 is formed on the anode electrode 41, and the cathode electrode 43 is formed therein. The anode electrode 41 and the electrolyte membrane 42 may have the same size. The central portion of the power generation cell support substrate 30 has an anode-side through hole 44 having a size larger than the cathode electrode 43 of the power generation cell 28 and inside the electrolyte membrane 42, and is processed such that the current collector 33 can come into contact with the anode electrode 41. As described above, the oxidant supply gas through hole 36, the oxidant discharge gas through hole 37, the fuel supply gas through hole 38, and the fuel discharge gas through hole 39 are provided on four sides of an outer periphery of the power generation cell counterbore 40. There may be a plurality of connection holes for gas supply and discharge.

The seal member 31 is for preventing mixing of the fuel gas and the oxidant gas, and is preferably made of a sheet material having excellent heat resistance and using a glass-based material or vermiculite as a raw material, such as at least one or more of vermiculite, leca, and steatite and has an elastic modulus less than that of the power generation cell substrate 30 and that of the electrode substrate 29A. In Embodiment 1, the seal member 31 uses three types of shapes.

FIG. 7 is a top plan view of the seal member 31A according to Embodiment 1.

FIG. 8 is a cross-sectional view taken along line A-A in FIG. 7. The seal member 31A is a seal member used between the electrode substrates 29A and 29B and the power generation cell support substrate 30 and between the power generation cell support substrate 30 and the separator 32. A seal member gas through hole 45 is formed in a central portion of the 31A and is open in a size not interfering with the power generation cell 28. The oxidant supply gas through hole 36, the oxidant discharge gas through hole 37, the fuel supply gas through hole 38, the fuel discharge gas through hole 39, and the through holes 35 through which the bolts 26 pass are provided in an outer peripheral portion at positions corresponding to those in the power generation cell support substrate 30.

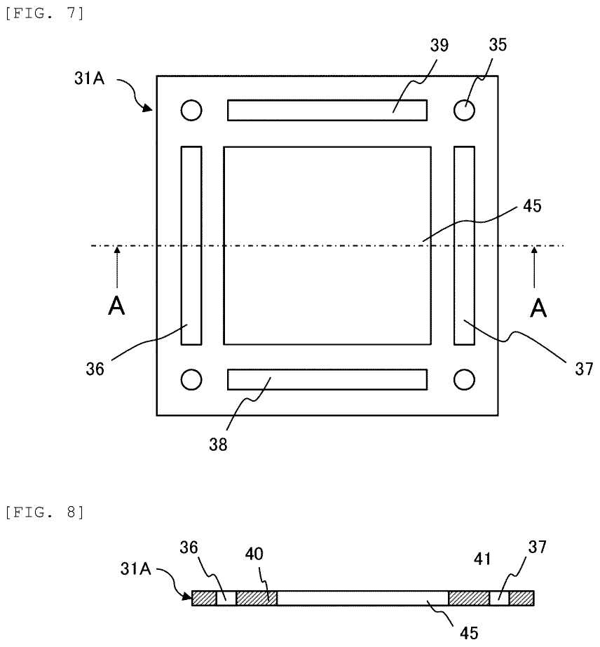

FIG. 9 is a top plan view of the seal member 31B which is used between the base plate 12 and the electrode substrate 29A, and a difference in shape from the seal member A is that the seal member gas through hole 45 in the central portion is not formed. The oxidant supply gas through hole 36, the oxidant discharge gas through hole 37, the fuel supply gas through hole 38, the fuel discharge gas through hole 39, and the through holes 35 through which the bolts 26 pass are formed in an outer peripheral portion.

Although not illustrated in the drawings, in a seal member 31C, the through holes 35 through which the bolts 26 pass are provided on an outer peripheral portion at four locations. A thickness of the seal member 31 is constant and is preferably 0.5 mm or less.

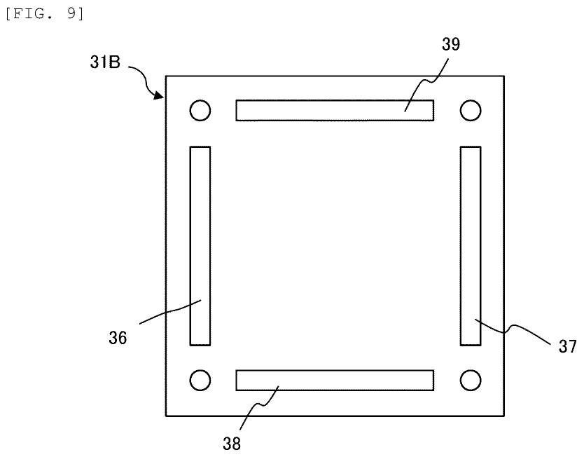

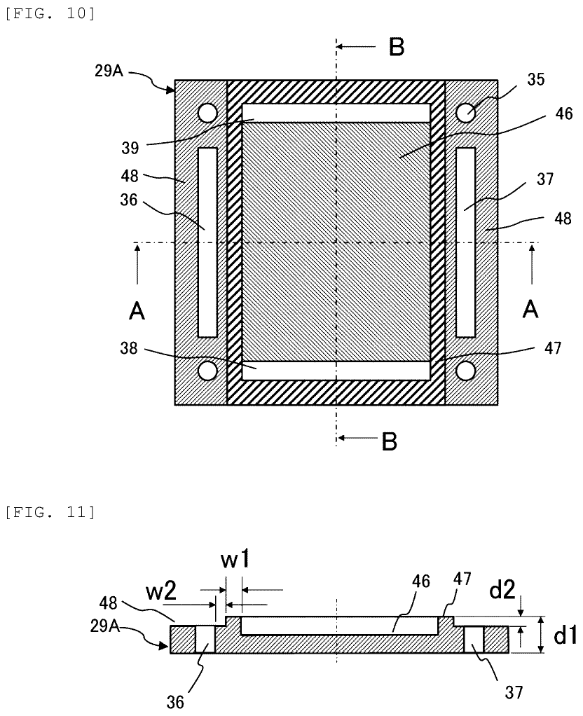

FIG. 10 is a top plan view of the electrode substrate 29A according to Embodiment 1.

FIG. 11 is a cross-sectional view taken along line A-A in FIG. 10.

FIG. 12 illustrates a cross-sectional view taken along line B-B in FIG. 10. In FIG. 10, an outer shape of the electrode substrate 29A is the same as that of the base plate 12 and that of the top plate 13 and is formed of metal. Similarly to the power generation cell support substrate 30, the through holes 35 through which the bolts 26 pass are formed in an outer peripheral portion at four locations, and a counterbore portion of the fuel gas flow path 46 is formed between the oxidant supply gas through hole 36, the oxidant discharge gas through hole 37, the fuel supply gas through hole 38, and the fuel discharge gas through hole 39. A lower side of the electrode substrate 29A is flat, and a thickness d1 of the fuel gas seal portion 47 on the outer periphery of the fuel supply gas through hole 38, the fuel discharge gas through hole 39, and the fuel gas flow path 46 is about 3 mm.

In contrast, a thickness of the oxidant gas seal portion 48 including the oxidant supply gas through hole 36, the oxidant discharge gas through hole 37, and the through holes 35 are formed to be less than d1 by d2 (0.1 mm), the thicknesses are different, and there is a step between the fuel gas seal portion 47 and the oxidant gas seal portion 48. A depth of the fuel gas flow path 46 is about 1 mm.

When a seal width of the fuel gas seal portion 47 between the fuel gas flow path 46 and the oxidant supply gas through hole 36 in the cross-sectional view taken along line A-A in FIG. 10 is w1, and a seal width of the oxidant gas seal portion 48 to the oxidant gas through hole is w2, by setting w1>w2, the number of regions having a density increased by compressing the contacting seal member 31A increases, and thus the effect of preventing the oxidant supply gas 16 from leaking into the fuel gas flow path 46 is improved.

In the cross-sectional view taken along line B-B in FIG. 12, for the outside of the fuel cell module 10 and the fuel gas flow path, the pressure in the fuel gas flow path 46 is higher than that in the outside, making it easier for the fuel supply gas 22 to leak to the outside, which causes a decrease in fuel utilization efficiency. Therefore, a seal width w3 between the outside and the fuel gas seal portion 47 of the fuel gas flow path 46 is preferably at least 4 mm or more. If the seal width becomes narrower, the amount of gas leakage tends to increase significantly.

A sum of the seal widths w1+w2 is also preferably 4 mm or more. Surface tolerances of the fuel gas seal portion 47 and the oxidant gas seal portion 48 are preferably small, and a constant density and a constant width are preferably ensured during the compression. In the present example, d2 is set to 0.1 mm, but this value is used when the thickness of the seal member 31A is 0.5 mm and differs depending on the thickness of the seal member. In the present example, when d2 is 0.15 mm or more, the gas leakage of the fuel supply gas 22 is reduced, but the gas leakage of the oxidant supply gas 16 increases, which is not preferable. If d2 is less than 0.02 mm, it is difficult to maintain the flatness of the fuel gas seal portion. Therefore, it can be said that a step range of the seal member 31A is preferably 0.02 mm or more and less than 0.15 mm.

It is preferable to design d2 such that a density ratio of a density of the seal member in contact with the fuel gas seal portion 47 to a density of the seal member in contact with the oxidant gas seal portion is 1.05 times or more to 1.5 times or less. In the present experiment, the density ratio of the fuel gas seal portion to the oxidant gas seal portion was 1.25 times. In the present embodiment, a thickness of a periphery of the through hole 35 used by the bolt 26 is set to be equal to that of the oxidant gas seal portion 48, but when there is an interval of 4 mm or more of the seal width w3 described above, the electrode substrate 29A may be thinned to a thickness such that the electrode substrate 29A does not come into contact with the seal member 31A. As the contact area with the seal member 31A decreases, a compressive force per unit area increases, and gas leakage can be relatively further reduced.

FIG. 13 is a plan view of the electrode substrate 29B according to Embodiment 1 as viewed from a lower side.

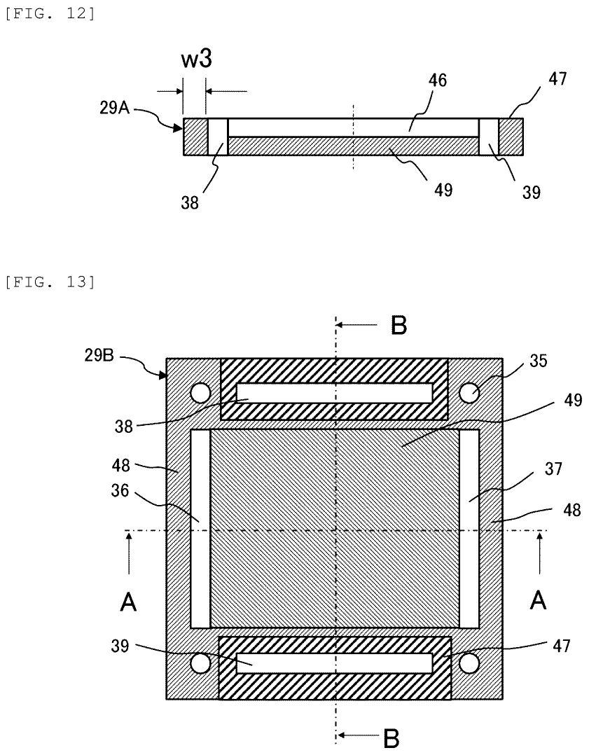

FIG. 14 is a cross-sectional view taken along line A-A in FIG. 13.

FIG. 15 is a cross-sectional view taken along line B-B in FIG. 13. An outer shape of the electrode substrate 29B is the same as that of the base plate 12 and that of the top plate 13 and is formed of metal. Similarly to the power generation cell support substrate 30, the through holes 35 through which the bolts 26 pass are formed in an outer peripheral portion, and a counterbore portion of the oxidant gas flow path 49 is formed between the fuel supply gas through hole 38, the fuel discharge gas through hole 39, the oxidant supply gas through hole 36, and the oxidant discharge gas through hole 37.

A thickness d3 of the electrode substrate 29B in the cross section taken along line A-A in FIG. 14 is 2.9 mm, and a counterbore depth of the oxidant gas flow path 49 is 0.9 mm. The seal width w3 between the outside and the oxidant gas seal portion 48 of the oxidant gas flow path 49 is preferably at least 4 mm or more. In the cross-sectional view taken along line B-B in FIG. 15, the lower side (top plate 13 side) of the electrode substrate 29B is flat, and the outer peripheries of the fuel supply gas through hole 38 and the fuel discharge gas through hole 39 are about 3 mm equal to the thickness d1 of the fuel gas seal portion 47.

There is an oxidant gas seal portion 48 from the fuel supply gas through hole 38 toward a central portion, d2 is reduced due to a step of 0.1 mm, and d3 described above is a thickness of 2.9 mm. The oxidant gas flow path 49 is formed in the central portion. The seal width w1 of the fuel gas seal portion 47 between the fuel supply gas through hole 38 and the oxidant gas flow path 49 and the seal width w2 of the oxidant gas seal portion 48 have the same relationship as that of the electrode substrate 29A described above, and by setting w1 >w2, the number of regions having a density increased by compressing the contacting seal member 31A increases, and thus the effect of preventing the oxidant supply gas 16 from leaking into the fuel supply gas through hole 38 is improved.

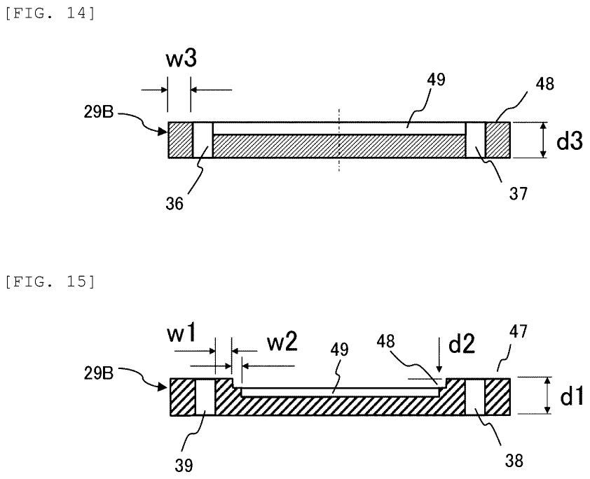

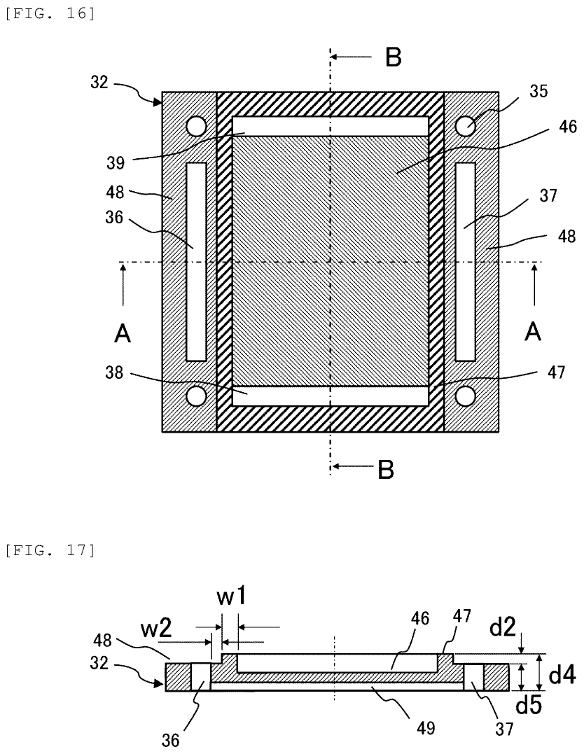

FIG. 16 is a top plan view of the separator 32 according to Embodiment 1.

FIG. 17 is a cross-sectional view taken along line A-A in FIG. 16.

FIG. 18 is a cross-sectional view taken along line B-B in FIG. 16. A shape of the separator 32 is a combination of a surface of the electrode substrate 29A in which the fuel gas flow path is formed and a surface of the electrode substrate 29B in which the oxidant gas flow path 49 is formed. In the separator 32, a total thickness is d1 of 3 mm, the through holes 35 are disposed at four locations, and the fuel supply gas through hole 38, the fuel discharge gas through hole 39, the oxidant supply gas through hole 36, and the oxidant discharge gas through hole 37 are further formed.

In FIG. 17, the fuel gas flow path 46 is formed at a central portion on an upper surface side of the separator 32 and has a depth of 1 mm. Similarly to the electrode substrate 29A, the fuel gas seal portion 47 is disposed on the outer periphery of the fuel gas flow path 46, and the oxidant gas seal portion 48 is formed on the outer periphery, which is reduced in thickness by d2 (0.1 mm).

In FIG. 17, since the entire lower side region is on the side of the oxidant gas flow path 49, d4 is reduced from d1 (3 mm) by d2 (0.1 mm) to 2.9 mm. A d5 is reduced by d2 (0.1 mm)×2 to become 2.8 mm because both surfaces are the oxidant gas flow path 49.

In FIG. 18, the oxidant gas flow path 49 having a depth of 1 mm is formed at the central portion on the lower surface side, the oxidant gas seal portion 48 is formed on the outer periphery, and the fuel gas seal portion 47 is formed on the further outer periphery, making the thickness larger than the oxidant gas seal portion 48 by d2 (0.1 mm). Since the fuel gas seal portion 47 is processed on both surfaces, the thickness of the periphery of the oxidant supply gas through hole 36 and the oxidant discharge gas through hole 37 is d5 (2.8 mm).

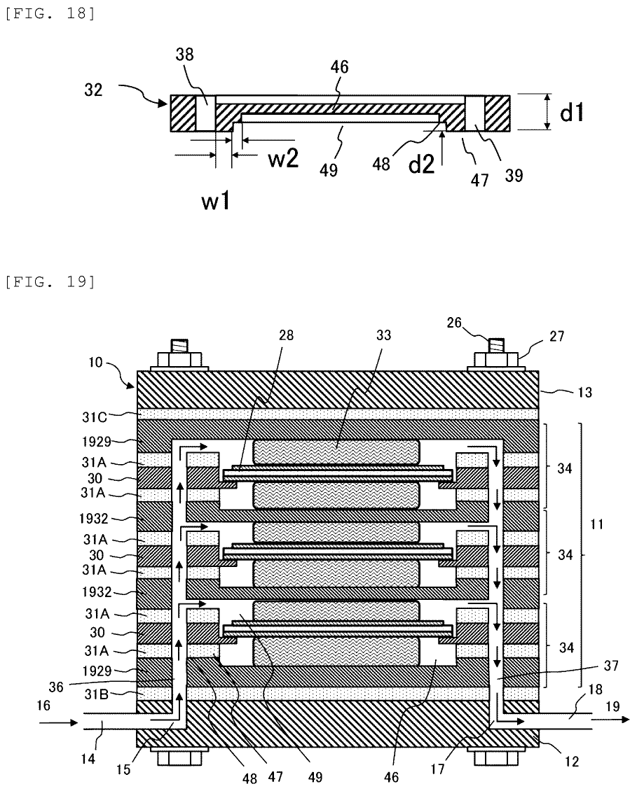

FIG. 19 is a cross-sectional view of a fuel cell module in a comparative example. A difference from Example 1 is an electrode substrate 1929 and a separator 1932. Both of the electrode substrate 1929 and the separator 1932 have the same thickness of the oxidant gas seal portion and the fuel gas seal portion without a step, and are in planar contact with the seal member 31.

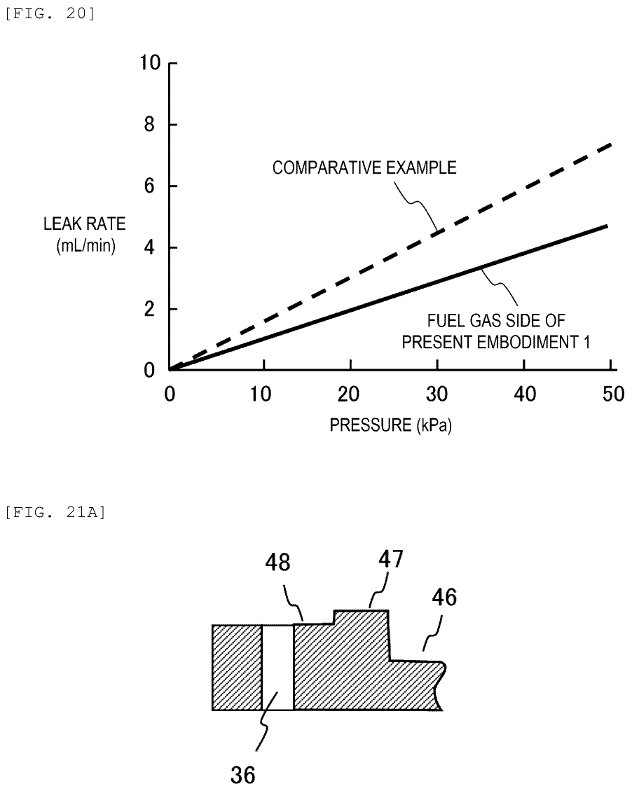

FIG. 20 illustrates leakage rates of the fuel cell modules according to the comparative example and Embodiment 1. To measure the gas leakage of the fuel cell module, pressure gauges are connected to the oxidant gas discharge pipe 18 and the fuel gas discharge pipe 24, and each pipe is sealed to prevent the supply gas from leaking. In a leakage rate test of the present example, after one of an oxidant gas pipe or a fuel gas pipe is open and the supply gas flows into the other pipe up to 50 kPa, and the supply gas side is sealed, thereby converting the leakage rate from a change of the pressure gauge over time. The leakage rate of the fuel cell module in the case of the comparative example was compared with the leakage rate of the fuel cell module according to Embodiment 1 in which a step of 0.1 mm was provided in the seal member having a thickness of 5 mm, with the pressure on the horizontal axis and the leakage rate on the vertical axis. As a result, in the comparative example, the leakage rate per layer was about 7.5 mL/min at 50 kPa for both the oxidant gas and the fuel gas. In contrast, in Embodiment 1, the leakage rate was about 7.5 mL/min on the oxidant gas side, which was the same as that in the comparative example, but the leakage rate was about 5 mL/min on the fuel gas side, demonstrating a gas leakage reduction effect of more than 30%. As a result, by providing a step between the fuel gas seal portion 47 and the oxidant gas seal portion 48 in the electrode substrates 29A and 29B and the separator 32, the density of the seal member of the fuel gas seal portion 47 was increased, and gas leakage was reduced. Therefore, it can be said that leakage of the oxidant gas into the fuel gas flow path and the like is also reduced.

As described above, by forming a step between the fuel gas seal portion 47 and the oxidant gas seal portion 48 on the same surface of the electrode substrate 29 or the separator 32 and changing the thickness of the seal member, it is possible to reduce gas leakage and to prevent a decrease in power generation output caused by the oxidant gas leakage to the fuel gas and a decrease in fuel use efficiency caused by the fuel gas leakage.

In Embodiment 1 in FIG. 20, a case of a step of 0.1 mm is illustrated, but it is confirmed that if the step is larger than 0.1 mm, the leakage rate decreases and a slope of the leakage rate caused by pressure decreases. However, as described above, since the leakage rate of the oxidant gas increases when the step is 0.15 mm or more, the depth of the step is preferably 0.02 or more and less than 0.1 mm in consideration of the balance between both leakage rates.

Next, shapes of the fuel gas seal portion 47 and the oxidant gas seal portion 48 of the electrode substrate 29A will be described.

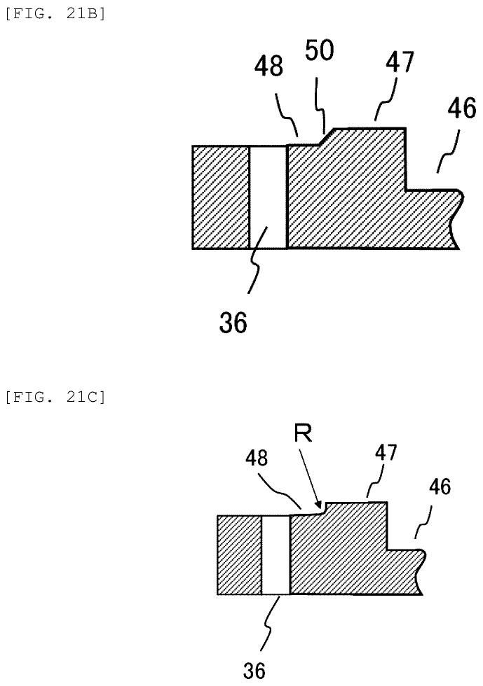

FIGS. 21A, 21B, and 21C illustrate shapes of three types of specifications of the oxidant gas seal portion 48. The step portion of the fuel gas seal portion 47 and the oxidant gas seal portion 48 are manufactured by several methods such as cutting and pressing. A shape of the step portion may also be a substantially vertical step as illustrated in FIG. 21A, and as illustrated in FIG. 21B, the step of the fuel gas seal portion 47 and the oxidant gas seal portion 48 portion may be inclined by an angle of a forward taper 50 of 45° or more. As illustrated in FIG. 21C, R or the like may be attached to a lower side of the step. Regarding the shape of this portion, it is important that when the contacting seal member is compressed, the seal member follows the shape and adheres closely, thereby making it possible to prevent gas leakage.

### EXAMPLE 2

Embodiment 2 is a fuel cell module in which a step between a fuel gas seal portion and an oxidant gas seal portion is provided, and a seal member is compressed from both sides of a separator or an electrode substrate to prevent gas leakage in the power generation cell support substrate 30. A difference from Example 1 is a structure of the power generation cell support substrate 30. Differences from Example 1 will be described below.

FIG. 22 is a cross-sectional view of a power generation cell support substrate 30-2 according to Embodiment 2 of the invention taken along direction A-A in FIG. 5.

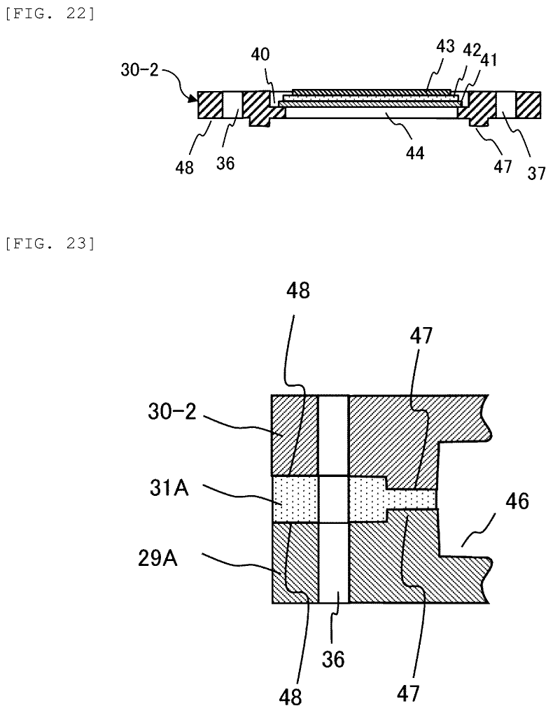

FIG. 23 is an enlarged cross-sectional view of an end portion of the power generation cell support substrate 30-2 in FIG. 22 and illustrates a state in which gas leakage is prevented in cooperation with the electrode substrate 29A in FIG. 11. In these drawings, the oxidant gas seal portion 48 having a thickness less than that of the fuel gas seal portion 47 surrounding the fuel supply gas through hole 38, the fuel discharge gas through hole 39, and the power generation cell counterbore 40 (these are as illustrated in FIG. 5) serving as a fuel gas flow path of the power generation cell support substrate 30-2 is formed to provide a step.

With this configuration, for example, when the seal member 31A and the separator 32 are stacked on the power generation cell support substrate 30-2 and compressed, the seal member 31 is further compressed and the effect of preventing gas leakage is improved because the fuel gas seal portion 47 is located above and below.

### EXAMPLE 3

Embodiment 3 is a fuel cell module in which the electrode substrate 29 has a step by a slit (groove) between an oxidant supply gas through hole fuel gas flow path to prevent gas leakage. A description will be made below.

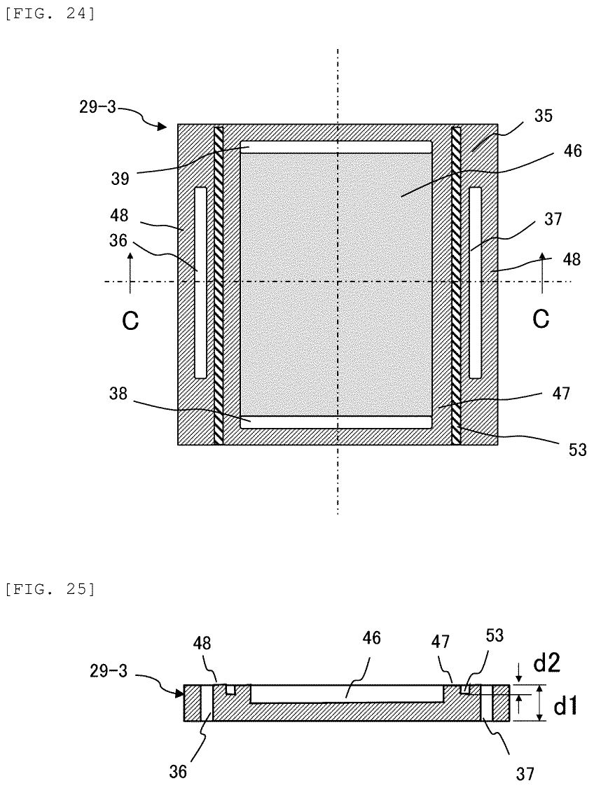

FIG. 24 is a plan view of an electrode substrate 29-3 according to Embodiment 3 of the invention.

FIG. 25 is a cross-sectional view of the electrode substrate 29-3 taken along line C-C in FIG. 24. Two steps are provided between the oxidant supply gas through hole 36 and the oxidant discharge gas through hole 37, and a slit portion 53 is provided to reduce the density between the two steps formed in the opposing seal member 31. A structure is formed in which an oxidant gas leaked by the high pressure of an oxidant is discharged to an outside before flowing toward the fuel gas flow path 46 due to a low-density portion of the seal member 31 formed by the slit portion 53.

A width of the slit portion 53 is preferably 0.5 mm or less to ensure a seal width between the fuel gas seal portion 47 and an oxidant supply gas connection hole. The depth d2 is preferably and preferably about 0.1 mm.

### Modifications of Invention

The invention is not limited to the above-described embodiments and includes various modifications. For example, the above-described embodiments have been described in detail to facilitate understanding of the invention, and the invention is not necessarily limited to those including all the configurations described above. In addition, a part of a configuration according to a certain embodiment can be replaced with a configuration according to another embodiment, and a configuration according to another embodiment can be added to a configuration according to a certain embodiment. In addition, another configuration can be added to a part of a configuration of each embodiment, and the part of the configuration of each embodiment can be deleted or replaced with another configuration.

According to the examples described above, among the fuel cells, in a compression-type fuel cell stack in which a seal member having a small elastic modulus is used between a substrate on which a cell is mounted and an electrode (separator) and is compressed upward and downward to prevent gas leakage, when the electrode substrate, the separator, or the substrate on which the fuel cell is mounted, in contact with the seal member, in which the portion covering the fuel gas region is increased in height relative to the portion covering the air region, is stacked and compressed, the thickness of the seal member in contact with the portion covering the fuel gas region is smaller than the thickness of the seal member in contact with the portion covering the air region, the density of the seal member increases, and therefore the fuel gas is prevented from flowing to the outside and air is prevented from flowing to an inside.

According to the above-described examples, it is possible to provide a high-performance clean energy source that does not emit pollutants such as a carbon dioxide gas and nitrogen oxides. It is possible to reduce carbon emission, prevent global warming, and contribute to the realization of a sustainable society.

### REFERENCE SIGNS LIST

10: fuel cell module
11: fuel cell stack
12: base plate
13: top plate
14: oxidant gas supply pipe
15: oxidant gas supply flow path
16: oxidant supply gas
17: oxidant gas discharge flow path
18: oxidant gas discharge pipe
19: oxidant discharge gas
20: fuel gas supply pipe
21: fuel gas supply flow path
22: fuel supply gas
23: fuel gas discharge flow path
24: fuel gas discharge pipe
25: fuel discharge gas
26: bolt
27: nut
28: power generation cell
29: electrode substrate
30: power generation cell support substrate
31: seal member
32: separator
33: current collector
34: power generation unit
35: through hole
36: oxidant supply gas through hole
37: oxidant discharge gas through hole
38: fuel supply gas through hole
39: fuel discharge gas through hole
41: anode electrode
42: electrolyte membrane
43: cathode electrode
45: seal member gas through hole
46: fuel gas flow path
47: fuel gas seal portion
48: oxidant gas seal portion
49: oxidant gas flow path
53: slit portion

1. A fuel cell module comprising:
a structure body in which a first member, a fuel cell, a support substrate that supports the fuel cell, and a second member are stacked;
a first supply path provided in the structure body and configured to allow a first gas to be supplied to the fuel cell;
a second supply path provided in the structure body and configured to allow a second gas to be supplied to the fuel cell; and
a seal member provided between the first supply path and the second supply path, wherein
the seal member is made of one material and is provided with a step in one surface, and the seal member on an outer peripheral portion of the second supply path has the same thickness.

2. The fuel cell module according to claim 1, wherein
the seal member has a non-uniform density in a region between the first supply path and the second supply path.

3. The fuel cell module according to claim 1, wherein
the seal member is sandwiched between at least one of the first member and the support substrate and the second member and the support substrate,
an elastic modulus of the seal member is less than elastic moduli of the first member, the second member, and the support substrate, and
the fuel cell module further includes a fixing member coupled to the structure body by applying a pressure in a stacking direction.

4. The fuel cell module according to claim 1, wherein
the seal member contains at least one or more selected from vermiculite, leca, and steatite.

5. The fuel cell module according to claim 1, wherein
a gas in the first supply path and a gas in the second supply path are supplied to have a pressure difference.

6. The fuel cell module according to claim 1, wherein
the first gas is air, the second gas is a fuel gas, and the first gas and the second gas are supplied such that a pressure of the gas in the first supply path is larger than a pressure of the gas in the second supply path.

7. The fuel cell module according to claim 1, wherein
in the step of the seal member, the seal member of the first supply path or the second supply path, which has a lower pressure, is thinner.

8. The fuel cell module according to claim 1, wherein
an interval between the step of the seal member and the second supply path is larger than an interval between the step of the seal member and the first supply path in a plan view of the seal member.

9. The fuel cell module according to claim 1, wherein
the step of the seal member is formed on both surfaces of the seal member in an up-down direction.

10. The fuel cell module according to claim 1, wherein
a density of the seal member is such that a film density of a region between the step of the seal member and the second supply path is 1.05 to 1.5 times larger than that of a region between the step of the seal member and the first supply path.

11. The fuel cell module according to claim 1, wherein
a depth of the step of the seal member is within a range of 0.02 mm or more and less than 0.15 mm.

12. The fuel cell module according to claim 1, wherein
a cross-sectional shape of the step is vertical or a slope other than being vertical.

13. The fuel cell module according to claim 1, wherein
a cross-sectional shape of the step has a curved surface portion.

14. The fuel cell module according to claim 1, wherein
the seal member on an outer peripheral portion of the first supply path has the same height, the height is the same height as a height of the seal member on the outer peripheral portion of the second supply path, and
the step is provided at two locations including a side of the first supply path and a side of the second supply path.

15. A manufacturing method for a fuel cell module, the fuel cell module including
a structure body in which a first plate-shaped member, a fuel cell, a support substrate that supports the fuel cell, and a second plate-shaped member are stacked,
a first supply path configured to allow a first gas to be supplied to the fuel cell,
a second supply path configured to allow a second gas to be supplied to the fuel cell, and
a seal member provided between the first supply path and the second supply path, wherein
the seal member is more easily deformed than the first plate-shaped member, the support substrate, and the second plate-shaped member,
at least one of the first plate-shaped member, the support substrate, and the second plate-shaped member has a step in a portion in contact with the seal member,
a pressure is applied in a stacking direction of the structure body to sandwich the seal member between at least two of the first plate-shaped member, the support substrate, and the second plate-shaped member, thereby forming the step in the seal member between the first supply path and the second supply path, and
at least one of the first gas and the second gas is prevented from moving in an in-plane direction of the first plate-shaped member, the support substrate, and the second plate-shaped member by the seal member.
